(19) United States
(12) Patent Application Publication
(10) Pub. No.: US 2016/0032982 A1
(43) Pub. Date: Feb. 4, 2016

(54) DAMPER ASSEMBLY INCLUDING AXIALLY FIXED FRICTION ASSEMBLY

(71) Applicant: Schaeffler Technologies AG & Co. KG, Herzogenaurach (DE)

(72) Inventor: Phong LU, Wooster, OH (US)

(21) Appl. No.: 14/805,052

(22) Filed: Jul. 21, 2015

Related U.S. Application Data
(60) Provisional application No. 62/030,976, filed on Jul. 30, 2014.

(51) Int. Cl. F16D 3/12; B21D 39/03; B21J 15/00

(52) U.S. Cl. CPC F16D 3/12; B21J 15/00; B21D 39/032; F16D 2250/0084

(57) ABSTRACT

A damper assembly for a marine vessel propulsion unit or a motor vehicle drive train is provided. The damper assembly includes a damper hub rotatably with respect to a center axis, a damper flange fixed for rotation on an outer surface of the damper hub, a cover plate coupled to the damper hub via the damper flange, an elastic element axially pressing against the cover plate, and a friction assembly axially fixed to the cover plate. The friction assembly supports the elastic element and maintains an orientation of the elastic element with respect to the cover plate during movement of a center axis of damper hub.

This claims the benefit to U.S. Provisional Patent Application No. 62/030,976 filed on Jul. 30, 2014, which is hereby incorporated by reference herein.

The present disclosure relates generally to damper assemblies and more specifically to damper assemblies for marine vessel propulsion units or motor vehicle drive trains.

### BACKGROUND

In marine vessel propulsion units, a rubber coupling damper is generally applied on a damper hub for connecting the damper hub to an engine crankshaft. Rubber coupling has no durability issue due to its excellent energy absorption for axial cycling from the drive train due the nature of rubber mass used. However, rubber coupling dampers are less capable of good NVH performance.

U.S. Pat. No. 8,454,446 discloses a damper mechanism for a clutch that is provided with a friction generating mechanism contrived to generate a hysteresis torque using a frictional resistance in order to absorb and attenuate torsional vibrations effectively. The friction generating mechanism has a first friction washer, a second friction washer, and a third friction washer.

FIG. 1 shows a conventional motor vehicle drive train damper assembly 10. Damper assembly 10 includes a damper hub 12 for connection to a transmission shaft and a damper flange 14 fixed for rotation with damper hub 12 by a splined connection. Damper assembly 10 further includes a cover plate 16 and a retainer plate 18 fixed together by spacers 20. An attachment element 22, for example a clutch disc, is fixed to the retainer plate. Attachment element 22 is configured for connecting damper hub 12 to an engine via plates 16, 18 and springs 24 held in circumferentially extending spaces of plates 16, 18. Plates 16, 18 are arranged to drive springs 24 during operation of damper assembly 10. Damper flange 14 extends into circumferential spaces between springs 24 such that springs 24 are arranged to drive damper flange 14 during operation of damper assembly 10, which in turn drives damper hub 12. An idle damper 26 is provided between retainer plate 18 and damper flange 14 and an axial spring 28, in the form of a diaphragm spring, is provided between damper flange 14 and cover plate 16. A washer 30 is provided between axial spring 28 and damper flange 14. Washer 30 is rotationally fixed to cover plate 16, but is not axially fixed to cover plate 16.

### SUMMARY OF THE INVENTION

Applying the conventional motor vehicle drive train damper assembly 10 to a marine vessel propulsion unit provides improved NVH performance, but excessive axial movements of the transmission input shaft during operation cause very high stress on axial spring 28 within damper assembly 10 due to axial cycling experienced by axial spring 28, which has been shown to lead to cracking of axial spring 28. Embodiments of the invention may reduce the axial cycling to an axial spring to zero or close to zero, which may keep the cycling stress as a possible to achieve intended durability with maximum possible spring energy allowed by the installation space. In addition to marine vessel propulsion units, embodiments of the damper assembly of the present invention may also be used in motor vehicle drive trains.

A damper assembly for a marine vessel propulsion unit or a motor vehicle drive train is provided. The damper assembly includes a damper hub rotatably with respect to a center axis, a damper flange fixed for rotation on an outer surface of the damper hub, a cover plate coupled to the damper hub via the damper flange, an elastic element axially pressing against the cover plate, and a friction assembly axially fixed to the cover plate. The friction assembly supports the elastic element and maintains an orientation of the elastic element with respect to the cover plate during movement of a center axis of damper hub.

A method of forming a damper assembly for a marine vessel propulsion unit or a motor vehicle drive train is also provided. The method includes fixing a cover plate, an elastic element axially pressing against the cover plate and a friction assembly axially together such that the friction assembly supports the elastic element and maintains an orientation of the elastic element with respect to the cover plate.

### BRIEF DESCRIPTION OF THE DRAWINGS

The present invention is described below by reference to the following drawings, in which:

FIG. 1 shows a conventional damper assembly;

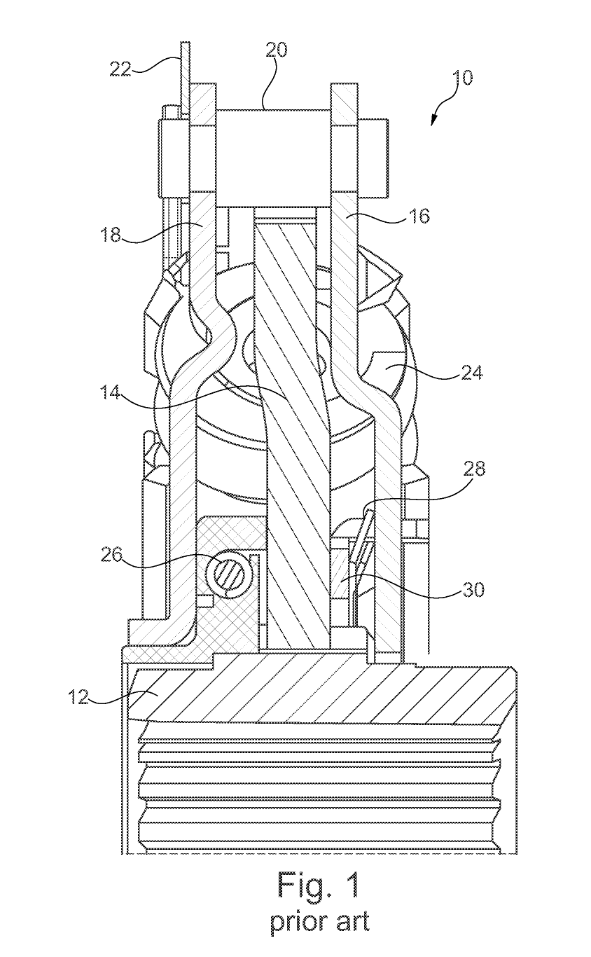

FIG. 2 shows a damper assembly in accordance with an embodiment of the present invention;

FIGS. 3a to 3h schematically illustrate the formation of a first washer and fixing of a cover plate, an elastic element and a friction assembly axially together;

FIG. 4 shows a damper assembly in accordance with another embodiment of the present invention; and

FIG. 5 shows a damper assembly in accordance with another further embodiment of the present invention.

### DETAILED DESCRIPTION

The present disclosure provides embodiments of damper assemblies with a friction package protected from axial cycling loads. This arrangement may advantageously improve durability by preventing axial cycling of the elastic element, e.g. a diaphragm spring, and improve performance by limiting the stackup and tolerance on a height of the spring. In a first embodiment, the spring is contained in a space formed by a cover plate on one side and a steel washer on the other side. The steel washer includes shoulders to prevent further compression of the spring via the contact thickness of the package, which prevents cycling of the diaphragm spring in the axial direction, and is expanded into slots in the cover plate so that the friction package is self-contained. A friction washer, which may be plastic, splined to the damper hub, is compressed between the spring and steel washer, and drivingly engaged with the flange by axial protrusions.

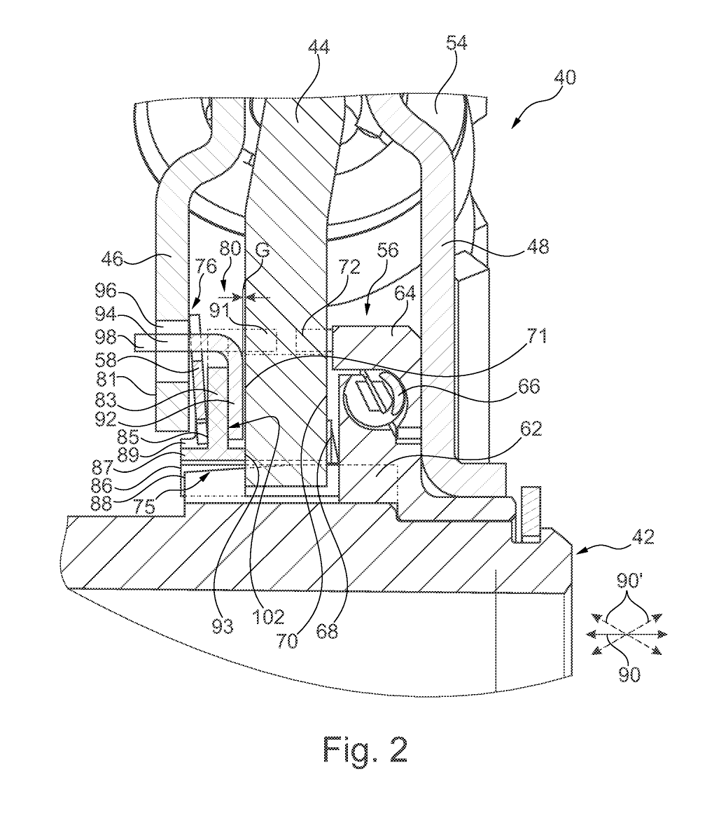

FIG. 2 shows a damper assembly 40 in accordance with a first embodiment of the present invention. Damper assembly 40 includes a damper hub 42 for connection to a transmission shaft and a damper flange 44 fixed for rotation with damper hub 42 by a splined connection. Damper assembly 40 further includes a cover plate 46 and a retainer plate 48 fixed together by spacers. An attachment element, for example a clutch disc or a spring plate, is fixed to an outer radial portion of retainer plate 48 for connecting damper hub 42 to an engine via plates 46, 48 and springs 54 held in circumferentially extending spaces of plates 46, 48. Plates 46, 48 are arranged to drive springs 54 during operation of damper assembly 40. Damper flange 44 extends into circumferential spaces between springs 54 such that springs 54 are arranged to drive damper flange 44 during operation of damper assembly 40, which in turn drives damper hub 42.

An idle damper 56 is provided between retainer plate 48 and damper flange 44. Idle damper 56 includes a radially inner portion 62 contacting an outer radial surface of damper hub 42, a radially outer portion 64 and a spring 66 held between portions 62, 64. An axial spring 68 contacts an engine-side axial surface 70 of damper flange 44 and an axial surface of radially inner portion 62 of idle damper 56. Axial spring 68, which may be a diaphragm spring, is compressed to press idle damper 56 against retainer plate 48. At radially outer portion 64, idle damper 56 includes axially extending protrusions 72 extending past axial surface 70 into spaces formed in damper flange 44 such that protrusions 72 are drivingly engaged with flange 44.

Damper assembly 40 is also is provided with an elastic element 58, in the form of an axial spring, e.g., a diaphragm spring, between damper flange 44 and cover plate 46. A radially outer end of elastic element 58 contacts an engine-side axial surface 76 of cover plate 46. A friction assembly 80 axially fixed to cover plate supports elastic element 58 and maintains an orientation of elastic element 58 with respect to cover plate 46 during movement of a center axis of damper hub 42, about which damper hub 42 rotates during operation. As schematically shown in FIG. 2, when damper hub 42 is perfectly aligned, the center axis of damper hub 42 has an untilted orientation 90. When a transmission shaft received inside of damper hub 42 is tilted axially, the center axis of damper hub 42 may have a tilted orientation 90′ that is angled with respect to untilted orientation 90. Friction assembly 80 is provided to maintain an orientation of elastic element 58 with respect to cover plate 46 when the center axis of damper hub 42 has a tilted orientation 90′ to prevent elastic element 58 from being cycled, which can cause breakage.

Friction assembly 80 includes a first washer 82 and a second washer 84. First washer 82 is formed of metal, which in a preferred embodiment is steel, and second washer 84 is a friction washer forming a transmission-side axial friction surface 85 for contacting a radially inner end of elastic element 58. In a preferred embodiment, friction washer 84 is formed of plastic; however, friction washer 84 may be formed of any material having a lower coefficient of friction than a coefficient of friction of the material forming damper flange 44, which is generally steel. Axial friction surface 85 is formed on a radially extending annular plate portion 83 of friction washer 84.

Friction washer 84 includes a radially inner splined surface formed by axially extending splines 86 extending radially inward from an axially extending base portion 87 for mating with axially extending splines 88 formed on the outer radial surface of damper hub 42 for fixing friction washer 84 for rotation with damper hub 42. Axially extending base portion 87 including an axial friction surface 93 for axially contacting damper flange 44 to minimize the friction transmitted to elastic element 58 from damper hub 42 and damper flange 44. In order to prevent splines 88 of damper hub 42, which are steel, from damaging the plastic splines 86 of friction washer 84, splines 88 include a tapered outer radial surface 75, which is angled with respect to the center axis of damper hub 42. Friction washer 84 also includes axially and radially extending projections 89, which are formed at an intersection of plate portion 83 and base portion 87, for mating with spaces formed at the radially inner end of elastic element 58 such that elastic element 58 is mechanically connected for rotation with friction washer 84. Friction washer 84 includes axially extending protrusions 91 extending past a transmission-side axial surface 71 of damper flange 44 into spaces formed in damper flange 44 such that protrusions 91 are drivingly engaged with flange 44.

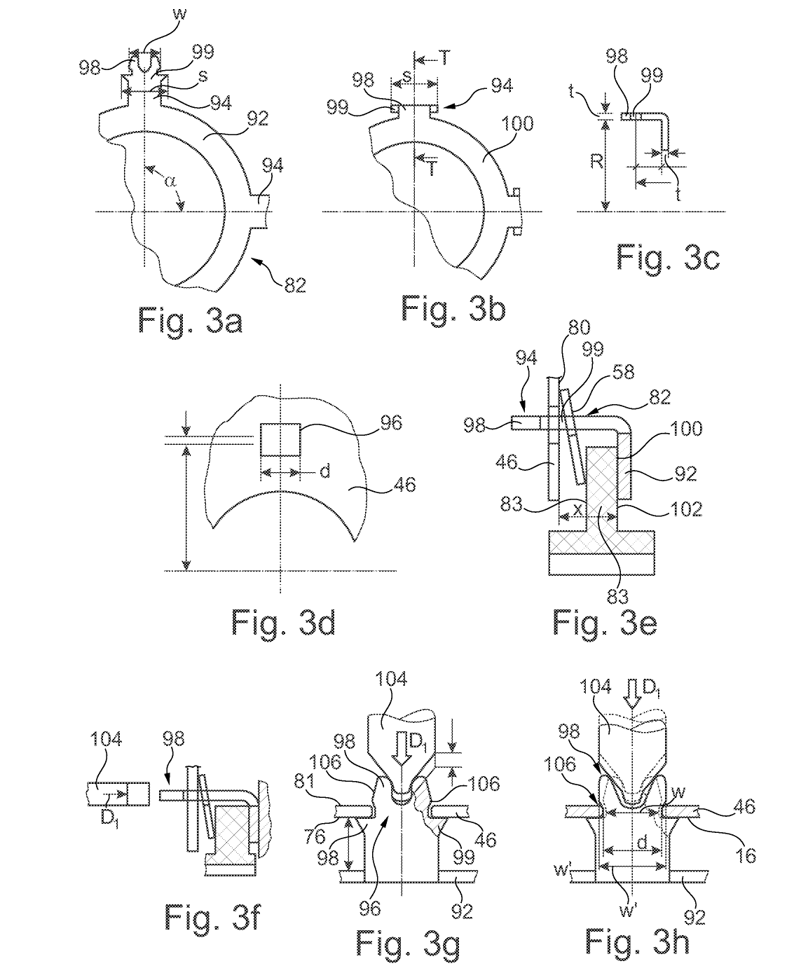

First washer 82 includes a radially extending annular plate portion 92 axially between plate portion 83 of friction washer 84 and transmission-side axial surface 71 of damper flange 44. First washer 82 further includes a plurality of axially extending tabs 94 axially extending from a radially outer end of plate portion 92 completely through corresponding slots 96 formed in cover plate 46. Tabs 94 also extend through spaces formed in the radially outer end of elastic element 58. As discussed further below with respect to FIGS. 3a to 3h, in this embodiment, tabs 94 include fingers 98 at an axially outer end thereof for axially fixing friction assembly 80 to cover plate 46. Fingers 98 contact a transmission-side axial surface 81 of cover plate 46, and along with shoulders 99 of tabs 94, prevent axial movement between first washer 82 and cover plate 46.

If possible, a small gap G between plate portion 92 of first washer 82 and damper flange 44 is kept larger than zero (i.e., no contact between plate portion 92 of first washer 82 and damper flange 44 under axial loading of elastic element 58), such that surface 72 of washer 84 contacts surface 71 of flange 44 to minimize the friction transmitted from flange 44 to elastic element 58. In this case, the cycling amplitude to elastic element 58 is zero. With a zero cycling amplitude, the mean stress level may be increased accordingly for the same durability requirement and the elastic energy of elastic element 58 may be increased with given installation limitation.

FIGS. 3a to 3h schematically illustrate the formation of first washer 82 and the fixing of cover plate 46, elastic element 58 and friction assembly 80 axially together such that friction assembly 80 supports elastic element 58 and maintains an orientation of elastic element 58 with respect to cover plate 46.

FIG. 3a shows a partial plan view of first washer 82 in a flat orientation, before tabs 94 are bent to extend axially away from annular plate portion 92. In a preferred embodiment, first washer 82 is a flat piece stamped out from sheet metal. In this exemplary embodiment, first washer 82 includes four tabs 94, each being spaced from the circumferentially adjacent tabs by an angle a of 90 degrees. As shown in FIG. 3a, each tab 94 includes two fingers 98 at the outer end thereof that are separated from each other by a gap. Outer lateral edges of fingers 98 are separated from each other by a distance w. Each tab 94 also includes two shoulders 99 positioned between plate portion 92 and fingers 98. Outer lateral edges of shoulders are separated from each other by a distance s, which is greater than distance w.

FIG. 3b shows a partial plan view of first washer 82 after tabs 94 are bent to extend axially away from annular plate portion 92. In a preferred embodiment, tabs 94 are bent to extend at an angle of approximately ninety degrees with to an axial surface 100 of plate portion 92. As shown in FIG. 3b, shoulders 99 extend laterally wider than fingers 98 at this point in the formation process. FIG. 3c shows a cross-sectional view of first washer 82 along T-T in FIG. 3b. As shown in FIG. 3c, tabs 94 and plate portion 92 are of a same uniform thickness t.

FIG. 3d shows a partial plan view of cover plate 46. Slots 96 in cover plate 46 are formed to have a width d that is greater than or equal to distance w and less than distance s.

FIG. 3e shows a cross-sectional side view of cover plate 46, elastic element 58 and friction assembly 80 assembled as a unit before friction assembly 80 is axially fixed to cover plate 46. Elastic element 58 and plate portion 83 of friction washer 84 are sandwiched axially between plate portion 92 of first washer 82 and cover plate 46 such that axial surface 100 of plate portion 92 contacts an axial surface 102 of plate portion 83, the radially inner end of elastic element 58 contacts axial surface 85 of plate portion 83 and the radially outer end of elastic element contacts axial surface 76 of cover plate 46. Tabs 94 of first washer 82, specifically fingers 98, extend through holes 96 in cover plate 46 and shoulders 99 of tabs 94 contact axial surface 76 of cover plate 46.

FIGS. 3f to 3h schematically illustrate a sequence of fixing tool 104 being applied to one of tabs 94 to axially fix friction assembly 80 to cover plate 46. Fixing tool 104 is forced in the axial direction Dl in between fingers 98 such that fingers 98 are forced laterally away from each other such that lateral edges 106 of fingers 98 are forced laterally outward to contact axial surface 81 of cover plate 46 such that cover plate 46 is wedged between fingers 98 and shoulders 99 to axially fix first washer 82 to cover plate 46, and thereby axially fix friction assembly 80 to cover plate 46. FIG. 3f shows fixing tool 104 before it contacts tab 94. FIG. 3g shows fixing tool 104 as fixing tool 104 initially contacts tab 94, with a tip of fixing tool 104 extending into a gap between fingers 98. FIG. 3h shows fixing tool 104 after fixing tool 104 has axially fixed first washer 82 to cover plate 46 by causing lateral edges 106 to extend outward and contact cover plate 46. As shown in FIG. 3h, after applying fixing tool 104 to friction assembly 80, lateral edges 106 of tab 94 are spaced from each other by a distance w′ that is greater than the width d of holes 96.

The height of shoulders 99 of tabs 94 do not change under axial loading of damper flange 44, which follows the axial motion of hub 42 caused by the excessive axial input shaft movements. This may ensure a constant space for the friction elements (i.e., elastic element 58 and friction washer 84) for all loading conditions.

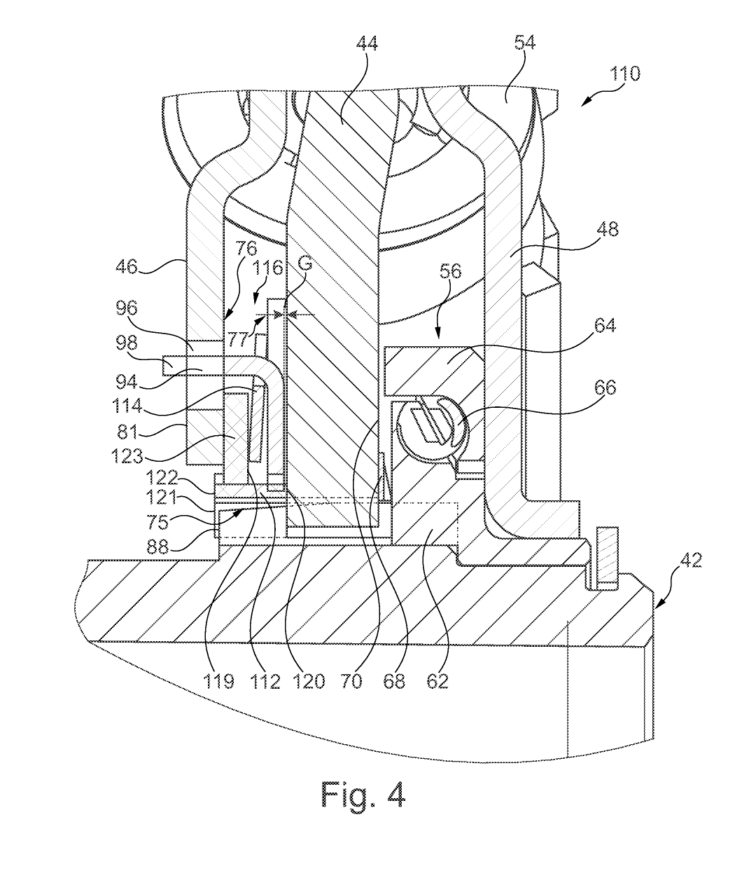

FIG. 4 shows a damper assembly in accordance with a further embodiment of the present invention. Damper assembly 110 is formed in a similar manner to damper assembly 40, with the differences being that friction washer 84 and elastic element 58 are replaced by a friction washer 112 and an elastic element 114.

Damper assembly 110 is also is provided elastic element 114, in the form of an axial spring, e.g., a diaphragm spring, on a transmission side of cover plate 46. More specifically, elastic element 114 is held inside of a friction assembly 116 axially fixed to cover plate 46 such that friction assembly 116 maintains an orientation of elastic element 114 with respect to cover plate 46 during movement of a center axis of damper hub 42 (i.e., when the center axis of damper hub 42 has an untilted orientation). Friction assembly 116 is provided to maintain an orientation of elastic element with respect to cover plate 46 when the center axis of damper hub 42 has a tilted orientation to prevent elastic element 114 from being damaged.

Friction assembly 116 includes first washer 82 and a second washer in the form of friction washer 112. In a preferred embodiment, friction washer 112 is formed of plastic; however, friction washer 112 may be formed of any material having a lower coefficient of friction than a coefficient of friction of the material forming damper flange 44, which is generally steel. Friction washer 112 includes an axial friction surface 119 for contacting a radially inner end of elastic element 114, which is positioned axially between washers 82, 112. Friction washer 112 also includes an axial friction surface 120 for axially contacting damper flange 44, minimizing the friction transmitted from flange 44 to elastic element 114.

Friction washer 112 includes a radially inner splined surface formed by axially extending splines 121 extending radially inward from an axially extending base portion 122 for mating with axially extending splines 88 formed on the outer radial surface of damper hub 42 for fixing friction washer 112 for rotation with damper hub 42. In order to prevent splines 88 of damper hub 42, which are steel, from damaging the plastic splines 121 of friction washer 112, splines 88 include a tapered outer radial surface 75, which is angled with respect to the center axis of damper hub 42. Friction washer 112 further includes a radially extending plate portion 123 for contacting axial surface 76 of cover plate 46.

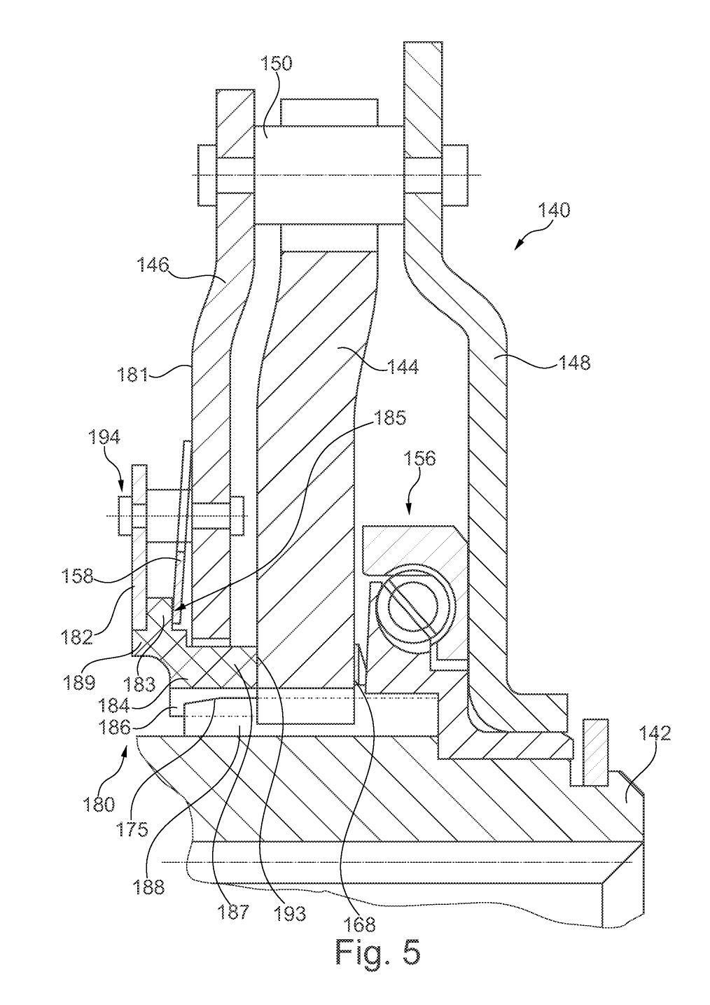

FIG. 5 shows a damper assembly 140 in accordance with another further embodiment of the present invention. Damper assembly 140 is formed in a similar manner to damper assembly 40, with one difference being a friction assembly 180 and an elastic element 158 being fixed to an outer axial surface (i.e., transmission-side axial surface) of a cover plate 146.

Damper assembly 140 includes a damper hub 142 for connection to a transmission shaft and a damper flange 144 fixed for rotation with damper hub 142 by a splined connection. Damper assembly 140 further includes a cover plate 146 and a retainer plate 148 fixed together by spacers 150. An attachment element, for example a clutch disc or a spring plate, may be fixed to an outer radial portion of retainer plate 148 for connecting damper hub 142 to an engine via plates 146, 148 and springs held in circumferentially extending spaces of plates 146, 148. Similar to the embodiment described in FIG. 2, plates 146, 148 are arranged to drive springs held in circumferentially extending spaces of plates 146, 148 during operation of damper assembly 140.

Additionally, an idle damper 156 and an axial spring 68 are provided between damper flange 144 and retainer plate 148 in essentially the same manner as described above with respect to FIG. 2.

Damper assembly 140 is also is provided with an elastic element 158, in the form of an axial spring, e.g., a diaphragm spring, on a transmission side of cover plate 146. More specifically, a radially outer end of elastic element 158 contacts a transmission-side axial surface 181 of cover plate 146. A friction assembly 180 axially fixed to cover plate 146 supports elastic element 158 and maintains an orientation of elastic element 158 with respect to cover plate 146 during movement of a center axis of damper hub 142 (i.e., when the center axis of damper hub 142 has an untilted orientation). Friction assembly 180 is provided to maintain an orientation of elastic element with respect to cover plate 146 when the center axis of damper hub 142 has a tilted orientation to prevent elastic element 158 from being damaged.

Friction assembly 180 includes a first washer 182 and a second washer 184. First washer 182 is formed of metal, which in a preferred embodiment is steel, and second washer 184 is a friction washer forming an engine-side axial friction surface 185 for contacting a radially inner end of elastic element 158. In a preferred embodiment, friction washer 184 is formed of plastic; however, friction washer 184 may be formed of any material having a lower coefficient of friction than a coefficient of friction of the material forming damper flange 144, which is generally steel. Axial friction surface 185 is formed on a radially extending annular plate portion 183 of friction washer 184.

Friction washer 184 includes a radially inner splined surface formed by axially extending splines 186 extending radially inward from an axially extending base portion 187 for mating with axially extending splines 188 formed on the outer radial surface of damper hub 142 for fixing friction washer 184 for rotation with damper hub 142. Axially extending base portion 187 includes an axial friction surface 193 for axially contacting damper flange 144 to minimize the friction transmitted to elastic element 158 from damper hub 142 and damper flange 144. In order to prevent splines 188 of damper hub 142, which are steel, from damaging the plastic splines 186 of friction washer 184, splines 188 include a tapered outer radial surface 175, which is angled with respect to the center axis of damper hub 142. Friction washer 184 further includes an axial projection 189 on an outer edge thereof for supporting a radially inner end of first washer 182.

In this embodiment, first washer 182 is formed by an annular plate that is axially fixed to cover plate 146 by rivets 194 extending axially through corresponding holes formed in first washer 182 and cover plate 146 and corresponding spaces formed in elastic element 158. Accordingly, this embodiment, friction assembly 180 is axially fixed to cover plate 146 by rivets 194.

Damper assemblies 40, 110, 140 provide a main damper friction package that may advantageously reduce the axial cycling to axial springs 58, 158 to zero or close to zero, which may keep the cycling stress as low as design possible to achieve intended durability with maximum possible spring energy allowed by the installation space.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A damper assembly for a marine vessel propulsion unit or a motor vehicle drive train comprising:
a damper hub rotatable with respect to a center axis;
a damper flange fixed for rotation with respect to an outer surface of the damper hub;
a cover plate coupled to the damper hub via the damper flange;
an elastic element axially pressing against the cover plate; and
a friction assembly axially fixed to the cover plate, the friction assembly supporting the elastic element and maintaining an orientation of the elastic element with respect to the cover plate during movement the damper hub center axis.

2. The damper assembly as recited in claim 1 wherein the friction assembly includes a first washer fixed to the cover plate and a second washer providing a friction surface for axially contacting the damper flange.

3. The damper assembly as recited in claim 2 wherein the elastic element is a diaphragm spring sandwiched axially between the friction surface of the second washer and the cover plate.

4. The damper assembly as recited in claim 2 wherein the first washer includes a first portion sandwiched between the second washer and the damper flange and a second portion fixed to the cover plate.

5. The damper assembly as recited in claim 4 wherein the second portion includes a tab extending axially through a slot in the cover plate.

6. The damper assembly as recited in claim 5 wherein:
the cover plate includes:
a first axial surface facing away from the damper flange; and,
a second axial surface facing toward the damper flange, and,
the tab includes finger elements contacting the first axial surface to fix the second portion to the cover plate.

7. The damper assembly as recited in claim 6 wherein the second portion includes shoulders contacting the second axial surface of the cover plate.

8. The damper assembly as recited in claim 2 further comprising a rivet for fixing the first washer to the cover plate.

9. The damper assembly as recited in claim 1 wherein the cover plate includes a first axial surface facing away from the damper flange and a second axial surface facing toward the damper flange, the elastic element contacting the first axial surface.

10. The damper assembly as recited in claim 1 wherein the friction assembly includes an inner splined surface and the damper hub includes an outer splined surface, the inner splined surface mating with the outer splined surface.

11. The damper assembly as recited in claim 10 wherein the outer splined surface is formed by a plurality of axially extending splines, the axially extending splines including a tapered outer radial surface, the tapered radial outer surface being angled with respect to a center axis of the damper hub.

12. The damper assembly as recited in claim 1 further comprising a retainer plate and a fastener fixing the retainer plate to the cover plate, the damper flange being axially between the cover plate and the retainer plate.

13. The damper assembly as recited in claim 12 further comprising an attachment element fixed to the retainer plate, the attachment element being configured for connecting the damper hub to an engine.

14. A method of forming a damper assembly for a marine vessel propulsion unit or a motor vehicle drive train comprising:
fixing a cover plate, an elastic element axially pressing the cover plate and a friction assembly axially together such that the friction assembly supports the elastic element and maintains an orientation of the elastic element with respect to the cover plate.

15. The method as recited in claim 14 further comprising connecting the cover plate to a damper hub via a damper flange.

16. The method as recited in claim 14 wherein the friction assembly includes a first washer fixed to the cover plate and a second washer providing a friction surface for axially contacting the damper flange.

17. The method as recited in claim 16 wherein the elastic element is a diaphragm spring and the fixing the cover plate, the diaphragm spring and the friction assembly together includes sandwiching the friction surface and the diaphragm spring axially between the first washer and the cover plate.

18. The method as recited in claim 14 wherein the fixing the cover plate, the elastic element and the friction assembly together includes inserting tabs of the first washer through slots in the cover plate.

19. The method as recited in claim 18 wherein the fixing the cover plate, the elastic element and the friction assembly together includes bending fingers of the tab toward an axial surface of the cover plate after inserting tabs of the first washer through slots in the cover plate.

20. The method as recited in claim 14 wherein the fixing the cover plate, the elastic element and the friction assembly together includes riveting the friction assembly to the cover plate such the elastic element is sandwiched axially between a friction surface of the friction assembly and the cover plate.
